(19) United States
(12) Patent Application Publication
(10) Pub. No.: US 2009/0250961 A1
(43) Pub. Date: Oct. 8, 2009

(54) Endgate Hinge for Motor Vehicle Having Dual Pivot Axes

(75) Inventor: James M. Townson, Clarkston, MI (US)

Correspondence Address: GENERAL MOTORS COMPANY;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 12/099,180

(22) Filed: Apr. 8, 2008

(51) Int. Cl. B62D 33/03; E05D 3/10

(52) U.S. Cl. 296/57.1; 16/367

(57) ABSTRACT

An assembly for opening and closing a passageway into a motor vehicle includes an endgate for opening and closing the passageway. First, second and third brackets are secured to the endgate, each bracket including a socket, a ball retained in the socket and a rod secured to the ball, the rod being able to pivot about an upright axis into alignment with a lateral axis, the first bracket being secured to the body at a first lateral side of the passageway, the second bracket being secured to the body at a second lateral side of the passageway opposite the first side, and the third bracket being secured to the body at the first lateral side and at an elevation such that the upright axis of the third bracket is aligned with the upright axis of the first bracket.

### BACKGROUND OF INVENTION

This invention relates generally to an endgate for a motor vehicle, and, more particularly, to an endgate and hinge assembly that allows the endgate to swing alternately about a lateral axis and an upright axis.

The tailgate at the back of a wagon, truck, station wagon, etc., is usually hinged along a lateral axis at the bottom of the tailgate to pivot downward for convenience in loading or unloading cargo. A door at the back of a vehicle hinged along a lateral axis at the top to open upward is often referred to as a hatch or liftgate.

In certain cases it is helpful and preferred that the vehicle have an endgate that can swing like a door about a vertical axis to facilitate access to the cargo area.

A more recent need exists in the automotive industry for a hinge assembly that supports an endgate such that the gate can swing about a horizontal axis and, like a door, about a vertical axis at the option of the user. It is preferable that each hinge for this multiple purpose is substantially identical, easily installed, occupy a small space and available at low cost.

### SUMMARY OF INVENTION

An assembly for opening and closing a passageway into the body of a motor vehicle includes an endgate for opening and closing the passageway; first, second and third brackets secured to the endgate, each bracket including a socket, a ball retained in the socket and a rod secured to the ball, the rod being able to pivot about an upright axis into alignment with a lateral axis. The first bracket is secured to the body at a first lateral side of the passageway. The second bracket is secured to the body at a second lateral side of the passageway opposite the first side such that the lateral axis of the second bracket is aligned with the lateral axis of the first bracket. The third bracket is secured to the body at the first lateral side and at an elevation spaced from an elevation of the first bracket such that the upright axis of the third bracket is aligned with the upright axis of the first bracket. In this way, the endgate can pivot between its opened and closed positions alternately about the lateral axis and the upright axis.

The ball and socket hinge brackets support the endgate on a rod, which is guided into alignment with the lateral axis by a slot formed in the socket. When the rods at each side of the endgate are aligned with the lateral axis, the endgate can pivot about the lateral axis. The slot guides the ball as it rotates in the socket about the upright axis permitting the rod and endgate to pivot also about the upright axis.

The assembly provides dual axis hinging having minimum weight and low cost. It enables the endgate to be removed from its assembled position on the vehicle with the use of simple tools.

An embodiment contemplates a method for reliably restricting the angular range of door travel on a vehicle such that contact between the door and a specialized, unusually wide vehicle body is prevented.

### BRIEF DESCRIPTION OF DRAWINGS

FIG. 1 is a rear view of a pickup truck showing the end gate opened about a lateral axis;

FIG. 2 is a rear view of the pickup truck showing the end gate opened about an upright axis;

FIG. 3 is a perspective view of a hinge bracket for supporting the endgate;

FIG. 4 is a perspective view showing the endgate opened about a lateral axis and supported on hinge brackets;

FIG. 5 is a perspective view showing a hinge bracket installed and positioned for opening the endgate about a lateral axis;

FIG. 6 is a perspective view showing the endgate being opened about an upright axis and supported on hinge brackets;

FIG. 7 is a perspective view showing a hinge bracket installed and positioned for opening the end gate about an upright axis; and

FIG. 8 is a cross sectional side view through the hinge bracket of FIG. 3.

### DETAILED DESCRIPTION

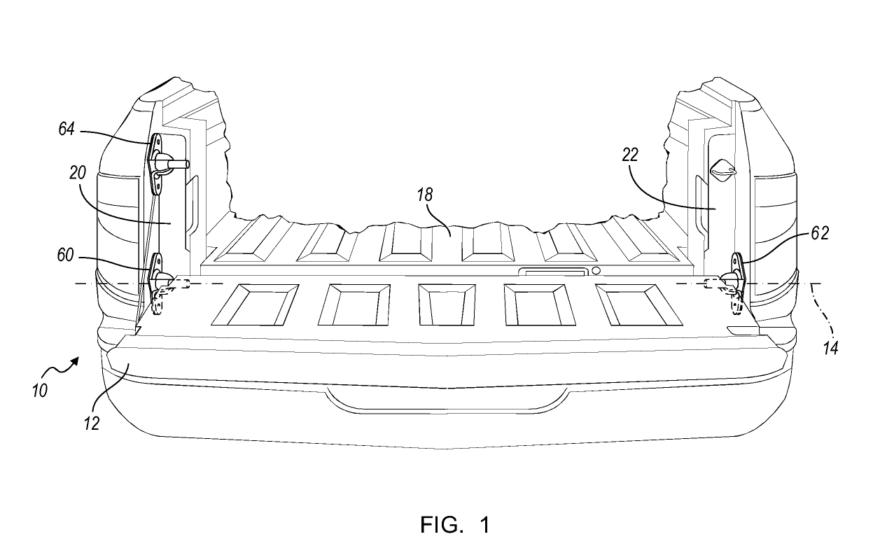

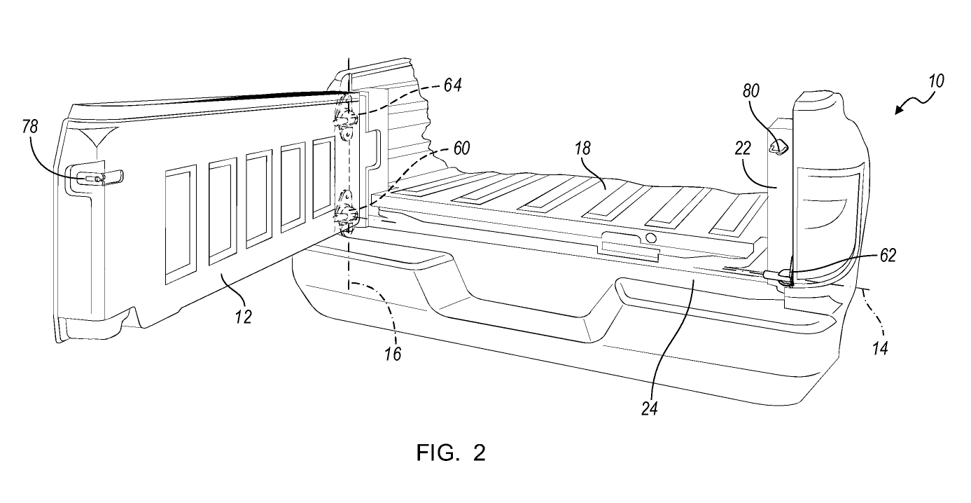

Referring now to the drawings, there is illustrated in FIGS. 1 and 2 a pickup truck 10 whose endgate 12 is hinged to open and close access to the truck bed 18 both about a lateral axis 14 and an upright axis 16. The cargo opening is formed with a left-side post 20, a right-side post 22, and a rail interconnecting the posts 20, 22. Preferably, axis 14 is horizontal and axis 16 is vertical, although they may be skewed somewhat with respect to the horizontal and vertical planes.

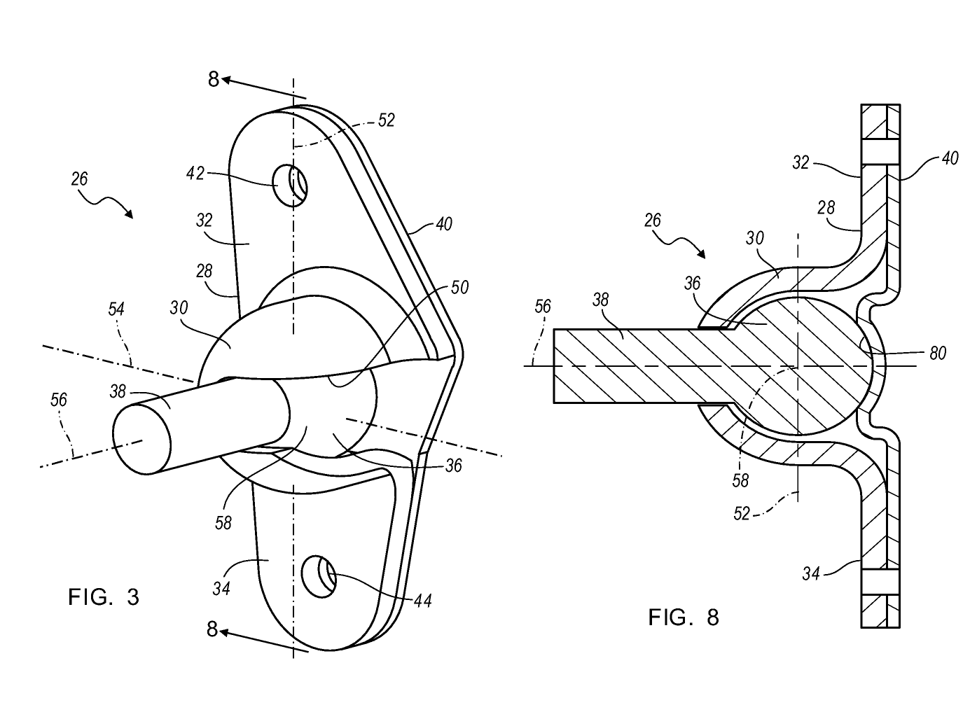

As shown in FIG. 3, each hinge bracket 26 includes a socket plate 28 formed with a concave, spherical socket 30; two mounting straps 32, 34; a convex spherical ball 36 located in the socket; a rod 38 secured to and extending radially from the ball; and a backing plate 40 parallel to the socket plate. The socket plate and backing plate are each formed with mutually aligned attachment holes 42, 44, each pair of holes receiving a fastener, preferably a threaded fastener that engages the body of the vehicle 10.

Socket 30 and socket plate 28 are formed with a slot 50, which permits rod 38 and ball 36 to rotate toward the rear of the vehicle 10 about an upright axis 52. The periphery of slot 50 limits rotation of rod 38 and ball 36 frontward about upright axis 52 due to the rod contacting the slot. Similarly, the periphery of slot 50 limits rotation of rod 38 and ball 36 about a longitudinal axis 54 due to the rod contacting the slot. Backing plate 36 and socket 30 limit displacement of rod 38 and ball 36 along the lateral axis 56, but the hinge assembly 26 provides no limit to rotation of rod 38 and ball 36 about lateral axis 56. The center 58 of socket 30 and ball 36 is located at the intersection of axes 52, 54 and 56.

As FIGS. 1 and 2 illustrate, the endgate 12 is supported on the vehicle 10 by a first hinge bracket 60, which is secured to the left-side post 20, a second hinge bracket 62, which is secured to the right-side post 22, and a third hinge bracket 64, which is secured to the left-side post 20 and is located at a higher elevation than that of bracket 60. Axis 56 of bracket 60 and axis 56 of bracket 62 are mutually aligned and coaxial with lateral axis 14. Axis 52 of bracket 60 and axis 52 of bracket 64 are mutually aligned and coaxial with upright axis 16.

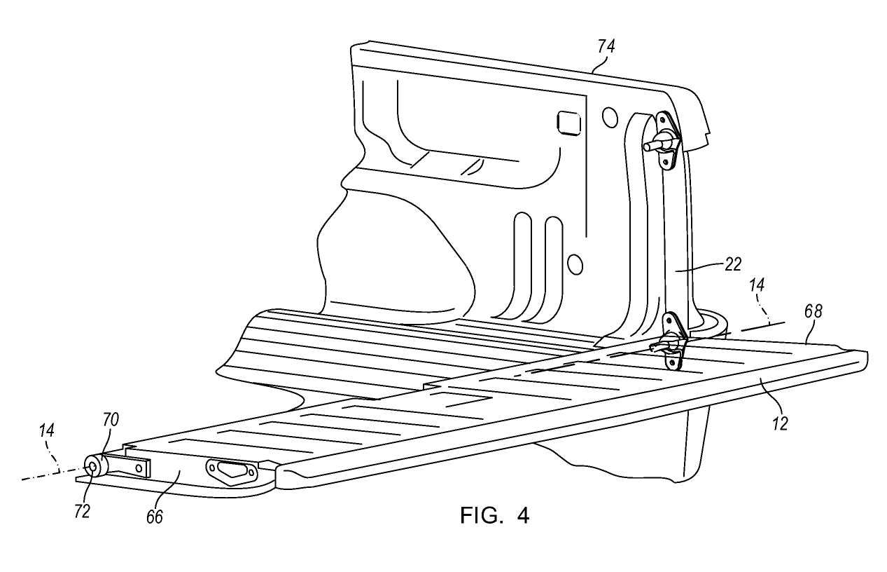

FIG. 4 shows endgate 12 rotated downward to an open position and supported on bracket 62 at post 22, and on bracket 60 at post 20. Each lateral edge 66, 68 of endgate 12 supports a receptacle 70, which is formed with a cylindrical opening 72, aligned with lateral axis 14 and sized to receive therein the rod 38 of the adjacent hinge bracket 60, 62.

For example, in FIG. 4, the rod 38 of hinge bracket 60 is received in receptacle 70 supporting the left-side of the endgate 12 and permitting the endgate to pivot about axis 14.

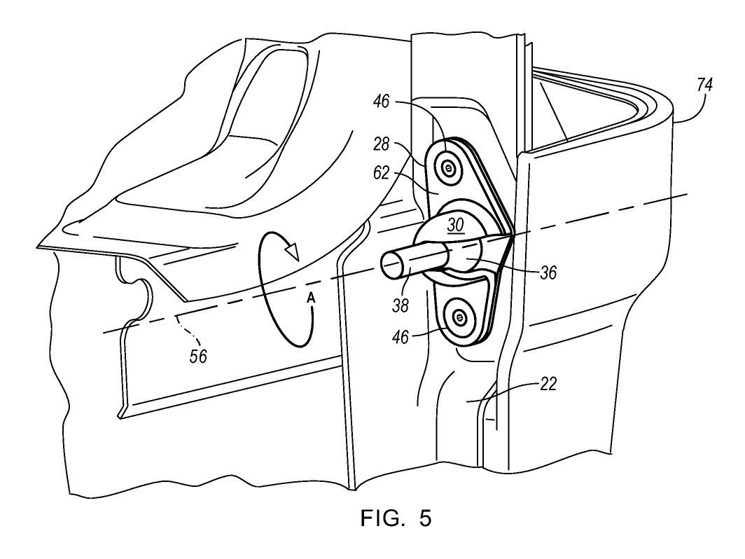

FIG. 5 shows hinge bracket 62 secured to the right-side post 22 of the right rear quarter panel 74 with the rod 38 of hinge bracket 62 ready for insertion in the receptacle 70, which is secured to lateral edge 68 of the endgate 12. In this way the right-side of endgate 12 is supported on rod 38 and post 22 and the endgate can pivot about axis 14, as indicated by arrow A.

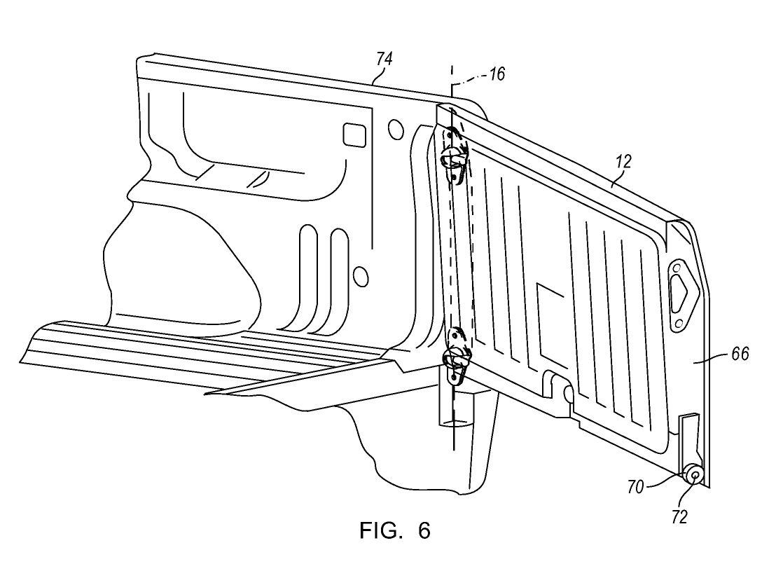

FIG. 6 shows endgate 12 rotated about upright axis 16 toward an open position and supported on upper and lower hinge brackets 60, 64, which, in this instance, are secured to the vehicle at right-side post 22 such that the upright axes of hinge brackets 60, 64 are aligned mutually and coaxially with the upright axis 16. The lateral edge 66 of endgate 12 supports a receptacle 70, which is formed with a cylindrical opening 72, aligned with lateral axis 14 and sized to receive therein the rod 38 of the adjacent hinge bracket 60. The right-side lateral edge 68 of endgate 12 supports upper and lower receptacles 70, which are each formed with a cylindrical opening 72, aligned with and sized to receive therein the rod 38 of the adjacent hinge bracket 60, 64.

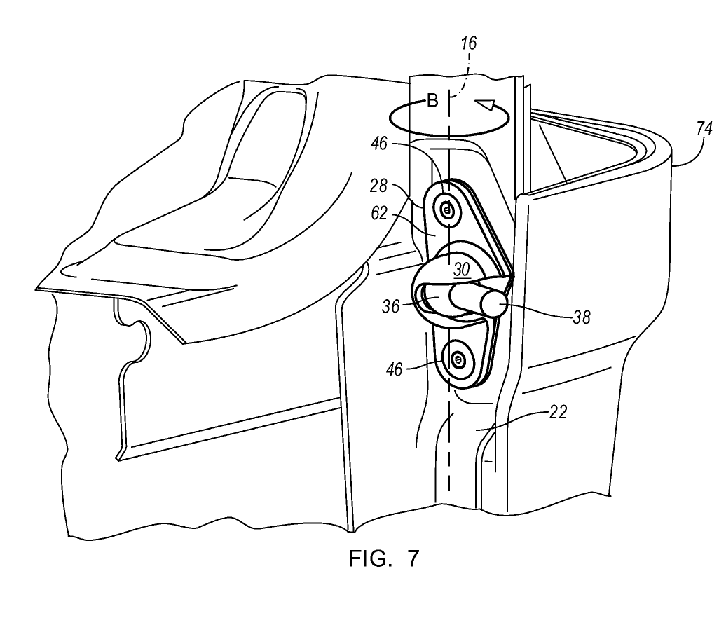

FIG. 7 shows a hinge bracket 62 secured to the right-side post 22 of the right rear quarter panel 74 with the rod 38 of the hinge bracket rotated about axis 16 and ready to be received in the receptacle 70 that is secured to lateral edge 68 of the endgate 12, thereby permitting the endgate to pivot about upright axis 16, as indicated by arrow B.

When the endgate swings about the upright axis 16 as shown in FIG. 1, the upper hinge bracket 64 is secured to the left-side post 22 of the left rear quarter panel 74 such that the rod 38 of hinge bracket 64 can be inserted into the upper receptacle 70 that is secured to lateral edge 66 of the endgate 12, permitting the endgate to pivot about upright axis 16.

FIG. 8 shows that backing plate 40 is formed with a partial, concave, spherical surface 80, which is complementary to the convex surface of ball 36 and is located in close proximity to the ball so that displacement of the ball and rod 38 along axis 56 is limited in each axial direction.

FIG. 2 shows a latch 78 secured to the endgate 12 and a striker 80 secured to post 22. When endgate 12 is pivoted either about axis 14 or axis 16 to a closed position, latch 78 engages the striker 80, thereby securing the endgate in the closed position.

In operation, endgate 12 can swing about lateral axis 14 between its open position, shown in FIGS. 1 and 4, and its closed position when the endgate is supported on the rods 38 of hinge brackets 60, 62 and each rod 38 of hinge brackets 60, 62 is aligned with axis 56 of the respective hinge bracket, as shown in FIGS. 3 and 5.

Alternatively, endgate 12 can swing about an upright axis 16 between the open position shown in FIGS. 2 and 6 and the closed position. In the open position, endgate 12 is supported on the rods 38 of hinge brackets 60, 64 and each rod 38 of hinge brackets 60, 64 is positioned as shown in FIG. 7. When a force is applied to close the endgate 12, the balls 36 of hinge brackets 60, 64 pivot about the axis 52 of the respective hinge bracket, causing the respective rod 38, guided within slot 50, to rotate about axis 52 to the positioned shown in FIG. 3. Then latch 78 engages striker 80, and the endgate is secured in the closed position.

Although the term “endgate” has been used in this description, the invention is applicable also to a tailgate hinged at the top to open downward, to a liftgate or hatch hinged at the top to open upward, and to a door hinged at either the left-side or right-side for convenience in loading or unloading cargo.

While certain embodiments of the present invention have been described in detail, those familiar with the art to which this invention relates will recognize various alternative designs and embodiments for practicing the invention as defined by the following claims.

What is claimed is:

1. An assembly for opening and closing a passageway into the body of a motor vehicle comprising:
an endgate for opening and closing the passageway; and
first, second and third brackets secured to the endgate, each bracket including a socket, a ball retained in the socket and a rod secured to the ball, the rod being able to pivot about an upright axis into alignment with a lateral axis, the first bracket being secured to the body at a first lateral side of the passageway, the second bracket being secured to the body at a second lateral side of the passageway opposite the first side such that the lateral axis of the second bracket is aligned with the lateral axis of the first bracket, and the third bracket being secured to the body at the first lateral side and at an elevation spaced from an elevation of the first bracket such that the upright axis of the third bracket is aligned with the upright axis of the first bracket.

2. The assembly of claim 1, wherein each lateral axis is located in a horizontal plane, and each upright axis is located in a vertical plane.

3. The assembly of claim 1, wherein:
each bracket includes a socket plate formed with the socket and a slot through which the rod extends and pivots about the upright axis; and
the endgate further includes a first receptacle secured to a first lateral side of the endgate and having a first opening for receiving the rod of the first bracket therein, a second receptacle secured to a second lateral side of the endgate opposite the first lateral side and having a second opening for receiving the rod of the second bracket therein.

4. The assembly of claim 3, wherein each bracket includes a backing plate contacting the socket plate and retaining the ball in the socket.

5. The assembly of claim 3, wherein the socket plate further includes attachment holes for use in securing the socket plate to the body.

6. The assembly of claim 3, wherein the rod of the first bracket and the rod of the second bracket support the endgate for rotation about the lateral axis.

7. The assembly of claim 3, wherein the rod of the first bracket and the rod of the third bracket support the endgate for rotation about the upright axis.

8. The assembly of claim 1, wherein:
each bracket includes a socket plate formed with the socket and a slot through which the rod extends and pivots about the upright axis; and
the endgate further includes a first receptacle secured to a first lateral side of the endgate and having a first opening for receiving the rod of the first hinge bracket therein, a second receptacle secured to a second lateral side of the endgate opposite the first lateral side and having a second opening for receiving the rod of the second hinge bracket therein, the first opening and the second opening being aligned mutually and coaxial with the lateral axis.

9. The assembly of claim 1, further comprising:
a latch secured to the endgate; and
a striker secured to the body for engagement by the latch, said engagement securing the endgate in a closed position and preventing pivoting of the endgate about the lateral axis and the upright axis.

10. An assembly for opening and closing a passageway into the body of a motor vehicle comprising:
an endgate for opening and closing the passageway; and
first, second and third brackets secured to the endgate, each bracket including a socket having a center located at an intersection of a lateral axis and an upright axis, a ball retained in the socket, and a rod secured to the ball and extending radially away from said center, pivoting movement of the rod being guided within a slot about the upright axis into alignment with the lateral axis, the first bracket being secured to the body at a first lateral side of the passageway, the second bracket being secured to the body at a second lateral side of the passageway opposite the first side such that the lateral axis of the second bracket is aligned with the lateral axis of the first bracket, and the third bracket being secured to the body at the first lateral side and at an elevation spaced from an elevation of the first bracket such that the upright axis of the third bracket is aligned with the upright axis of the first bracket.

11. The assembly of claim 10, wherein each lateral axis is located in a horizontal plane, and each upright axis is located in a vertical plane.

12. The assembly of claim 10, wherein:
each bracket includes a socket plate formed with the socket and the slot through which the rod extends and pivots about the upright axis; and
the endgate further includes a first receptacle secured to a first lateral side of the endgate and having a first opening for receiving the rod of the first bracket therein, a second receptacle secured to a second lateral side of the endgate opposite the first lateral side and having a second opening for receiving the rod of the second bracket therein.

13. The assembly of claim 12, wherein each bracket includes a backing plate contacting the socket plate and retaining the ball in the socket.

14. The assembly of claim 12, wherein the socket plate further includes attachment holes for use in securing the socket plate to the body.

15. The assembly of claim 12, wherein the rod of the first bracket and the rod of the second bracket support the endgate for rotation about the lateral axis.

16. The assembly of claim 12, wherein the rod of the first bracket and the rod of the third bracket support the endgate for rotation about the upright axis.

17. The assembly of claim 10, wherein:
each bracket includes a socket plate formed with the socket and the slot through which the rod extends and pivots about the upright axis; and
the endgate further includes a first receptacle secured to a first lateral side of the endgate and having a first opening for receiving the rod of the first hinge bracket therein, a second receptacle secured to a second lateral side of the endgate opposite the first lateral side and having a second opening for receiving the rod of the second hinge bracket therein, the first opening and the second opening being aligned mutually and coaxial with the lateral axis.
